(19) United States
(12) Patent Application Publication
(10) Pub. No.: US 2024/0400762 A1
(43) Pub. Date: Dec. 5, 2024

(54) POLYIMIDE AND POLYIMIDE PRECURSOR

(71) Applicant: UBE CORPORATION, Ube-shi, Yamaguchi (JP)

(72) Inventors: Daisuke WATANABE, Tokyo (JP); Asako KYOBU, Tokyo (JP)

(73) Assignee: UBE CORPORATION, Ube-shi, Yamaguchi (JP)

(21) Appl. No.: 18/692,539

(22) PCT Filed: Aug. 18, 2022
(86) PCT No.: PCT/JP2022/031168

§ 371 Date: Mar. 15, 2024

(30) Foreign Application Priority Data
Sep. 17, 2021 (JP) 2021-152309

(51) Int. Cl. C08G 73/10

(52) U.S. Cl. CPC C08G 73/10

(57) ABSTRACT

A polyimide which is a polycondensate of a monomer (A) comprising a tetracarboxylic acid dianhydride represented by the following general formula (1):

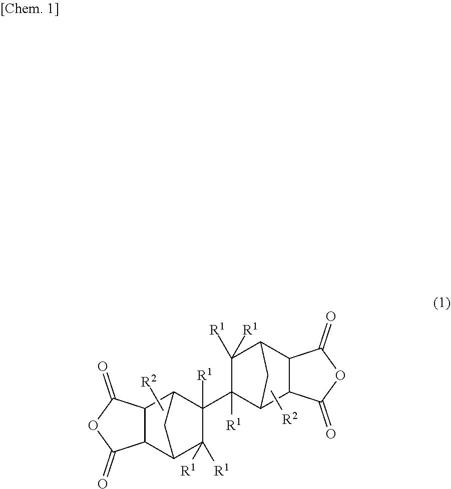

(In formula (1), R¹s each independently represent a hydrogen atom etc., and R²s each independently represent a hydrogen atom etc.)
and a monomer (B) comprising a diamine compound, wherein
a content ratio of the monomer (A) is 100.2 moles to 105 moles relative to 100 moles of the monomer (B).

### TECHNICAL FIELD

The present invention relates to a polyimide and a polyimide precursor.

### BACKGROUND ART

Polyimides have conventionally attracted attention as materials having high heat resistance and being light and flexible. In the field of such polyimides, polyimides having high light transmittance suitable for uses such as glass substitutes as well as heat resistance have been desired, and in recent years, various polyimides have been developed.

For example, International Publication No. WO2017/030019 (Patent Literature 1) discloses a polyimide obtained by polymerizing a tetracarboxylic acid dianhydride represented by the following formula (A):

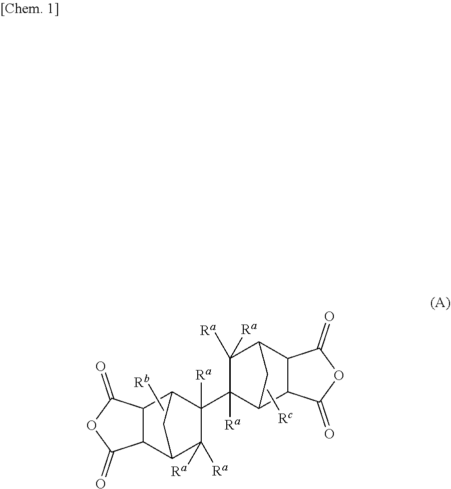

[In the formula, R^{a} each independently represents a hydrogen atom and the like, and R^{b} and R^{c} each independently represent a hydrogen atom and the like.]
and an aromatic diamine. The polyimide described in Patent Literature 1 has a sufficiently high level of heat resistance while having high light transmittance. However, in the field of such polyimides, polyimides having higher heat resistance while maintaining high light transmittance have been desired.

### CITATION LIST

### Patent Literature

[PTL 1] International Publication No. WO2017/030019

### SUMMARY OF INVENTION

### Technical Problem

The present invention has been made in view of the problems of the related art described above, and an object thereof is to provide a polyimide capable of achieving a higher level of heat resistance while having a high level of light transmittance, and a polyimide precursor suitably usable for producing the polyimide.

### Solution to Problem

The present inventors have conducted extensive research to achieve the above object. First, when the present inventors analyzed the tetracarboxylic acid dianhydride represented by the formula (A) obtained by the method described in Patent Literature 1, they found that the product obtained during synthesis of the tetracarboxylic acid dianhydride contained several percent of reaction intermediates (compounds represented by general formulas (2) to (9) described later). Then, the present inventors conducted further research and have found that when reacting a monomer (A) comprising a tetracarboxylic acid dianhydride represented by the following general formula (1) with a monomer (B) comprising a diamine compound, by increasing the usage amount of the monomer (A) comprising the tetracarboxylic acid dianhydride by approximately the content percentage of the reaction intermediates of the tetracarboxylic acid dianhydride contained in the monomer (A), surprisingly, it is possible to obtain a polyimide capable of achieving a higher level of heat resistance while maintaining a high level of light transmittance, thereby completing the present invention.

That is, the polyimide of the present invention is a polycondensate of a monomer (A) comprising a tetracarboxylic acid dianhydride represented by the following general formula (1):

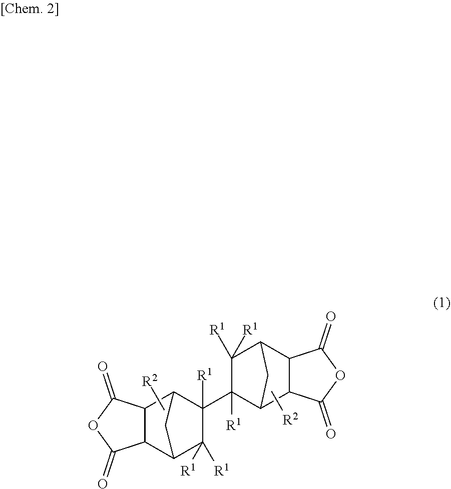

[In formula (1), R¹s each independently represent one selected from the group consisting of a hydrogen atom, an alkyl group having 1 to 10 carbon atoms, a hydroxy group, and a nitro group, or two R¹s bonded to the same carbon atom may together form a methylene group, and
R²s each independently represent one selected from the group consisting of a hydrogen atom and an alkyl group having 1 to 10 carbon atoms.]
and a monomer (B) comprising a diamine compound, wherein
the content ratio of the monomer (A) is 100.2 moles to 105 moles relative to 100 moles of the monomer (B).

The polyimide precursor of the present invention is a polyaddition product of a monomer (A) comprising a tetracarboxylic acid dianhydride represented by the general formula (1) and a monomer (B) comprising a diamine compound, wherein
the content ratio of the monomer (A) is 100.2 moles to 105 moles relative to 100 moles of the monomer (B).

In the polyimide and the polyimide precursor of the present invention, the monomer (A) may contain at least one ester compound selected from compounds represented by the following general formulas (2) to (9):

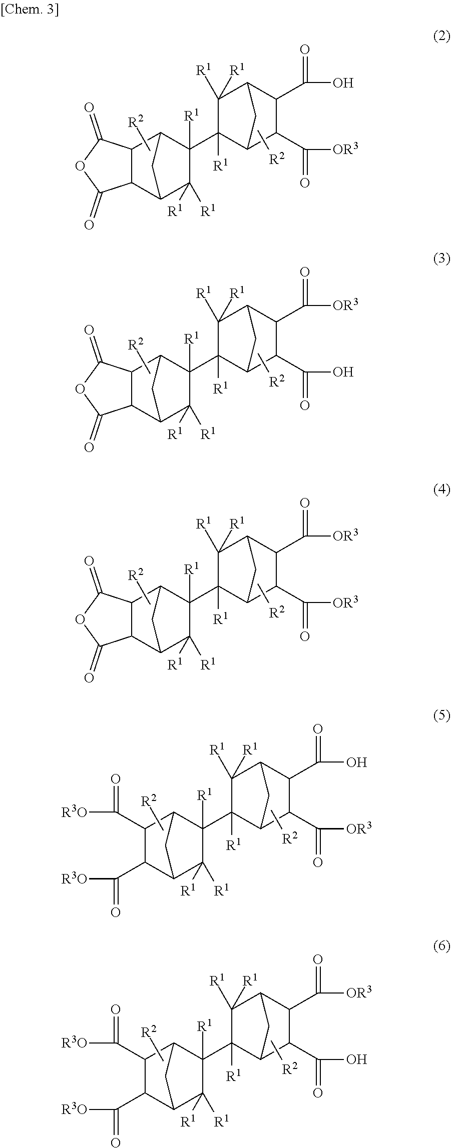

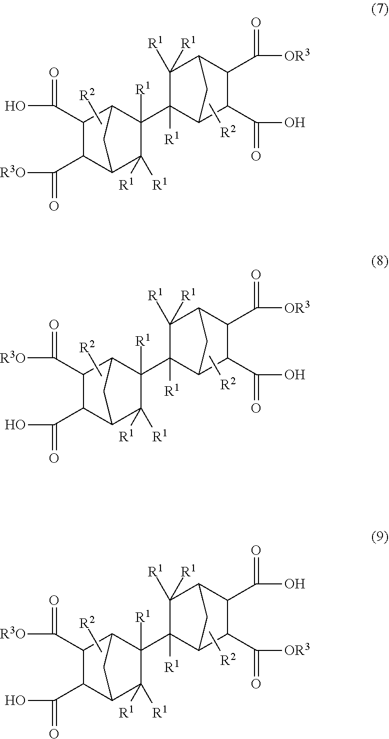

[In formulas (2) to (9), R¹ and R² are the same as R¹ and R² in the general formula (1), and R 3s each independently represent one selected from the group consisting of an alkyl group having 1 to 10 carbon atoms, a cycloalkyl group having 3 to 10 carbon atoms, an alkenyl group having 2 to 10 carbon atoms, an aryl group having 6 to 20 carbon atoms, and an aralkyl group having 7 to 20 carbon atoms.]
in a ratio such that the total amount of the ester compounds is 5% by mass or less relative to the total amount of the compounds represented by the general formulas (1) to (9) contained in the monomer (A).

### Advantageous Effects of Invention

According to the present invention, it is possible to provide a polyimide capable of achieving a higher level of heat resistance while having a high level of light transmittance, and a polyimide precursor suitably usable for producing the polyimide.

### DESCRIPTION OF EMBODIMENTS

Hereinafter, the present invention will be described in detail based on preferred embodiments thereof. In the present specification, unless otherwise specified, for numerical values X and Y, the notation “X to Y” means “X or more and Y or less.” In such notation, when only the numerical value Y has a unit attached thereto, the unit also applies to the numerical value X.

### [Polyimide]

The polyimide of the present invention is a polycondensate of a monomer (A) comprising a tetracarboxylic acid dianhydride represented by the general formula (1) and a monomer (B) comprising a diamine compound, wherein the content ratio of the monomer (A) is 100.2 moles to 105 moles relative to 100 moles of the monomer (B).

### <Regarding Monomer (A)>

The monomer (A) is a monomer component comprising a tetracarboxylic acid dianhydride represented by the following general formula (1) (acid dianhydride-based monomer component):

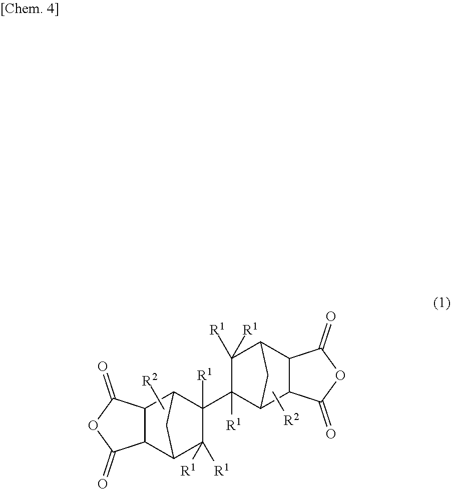

[In formula (1), R¹s each independently represent one selected from the group consisting of a hydrogen atom, an alkyl group having 1 to 10 carbon atoms, a hydroxy group, and a nitro group, or two R¹s bonded to the same carbon atom may together form a methylene group, and
R²s each independently represent one selected from the group consisting of a hydrogen atom and an alkyl group having 1 to 10 carbon atoms.]

The alkyl group that can be selected as R¹ in the general formula (1) is an alkyl group having 1 to 10 carbon atoms. When the number of carbon atoms is 10 or less, the heat resistance of the resulting polyimide tends to be higher when used as a monomer for polyimide compared to when exceeding 10 carbon atoms. From the viewpoint of obtaining higher heat resistance when producing the polyimide, the number of carbon atoms of the alkyl group that can be selected as R¹ is preferably 1 to 6, more preferably 1 to 5, further preferably 1 to 4, and particularly preferably 1 to 3. The alkyl group that can be selected as R¹ may be linear or branched.

Also, among the multiple R¹s in the general formula (1), two R¹s bonded to the same carbon atom may together form a methylene group (═CH₂). That is, two R¹s bonded to the same carbon atom in the general formula (1) may be bonded together to the carbon atom (among the carbon atoms forming the norbornane ring structure, the carbon atom to which two R¹s are bonded) as a methylene group (methylene group) by a double bond.

From the viewpoint of obtaining higher heat resistance when producing the polyimide, ease of obtaining raw materials, ease of purification, and the like, the multiple R¹s in the general formula (1) are each independently preferably a hydrogen atom, a methyl group, an ethyl group, an n-propyl group, or an isopropyl group, and particularly preferably a hydrogen atom or a methyl group. The multiple R¹s in formula (1) may be the same or different, but from the viewpoint of ease of purification and the like, it is preferable that they are the same.

R² in the general formula (1) is each independently one selected from the group consisting of a hydrogen atom and an alkyl group having 1 to 10 carbon atoms. When the number of carbon atoms of the alkyl group that can be selected as R² is 10 or less, the heat resistance of the resulting polyimide tends to be higher when used as a monomer for polyimide compared to when exceeding 10 carbon atoms. From the viewpoint of obtaining higher heat resistance when producing the polyimide, the number of carbon atoms of the alkyl group that can be selected as R² is preferably 1 to 6, more preferably 1 to 5, further preferably 1 to 4, and particularly preferably 1 to 3. The alkyl group that can be selected as R² may be linear or branched.

From the viewpoint of obtaining higher heat resistance when producing the polyimide, ease of obtaining raw materials, ease of purification, and the like, R²s in the general formula (1) are each independently preferably a hydrogen atom, a methyl group, an ethyl group, an n-propyl group, or an isopropyl group, and particularly preferably a hydrogen atom or a methyl group. The multiple R²s in formula (1) may be the same or different, but from the viewpoint of ease of purification and the like, it is preferable that they are the same.

It is particularly preferable that all of the multiple R¹s and R²s in the general formula (1) are hydrogen atoms. Thus, when the substituents represented by R¹ and R² in the compound represented by the general formula (1) are all hydrogen atoms, the resulting polyimide tends to have higher heat resistance when producing the polyimide.

The method for producing the tetracarboxylic acid dianhydride of the present invention is not particularly limited, but the method described in International Publication No. WO2017/030019 can be employed. As the tetracarboxylic acid dianhydride represented by the general formula (1), a commercially available sample from ENEOS Corporation may be used, for example.

The tetracarboxylic acid dianhydride represented by the general formula (1) is basically produced, as described in International Publication No. WO2017/030019, by using a tetraester compound represented by the following general formula (10) as a raw material compound and heating it in a lower carboxylic acid:

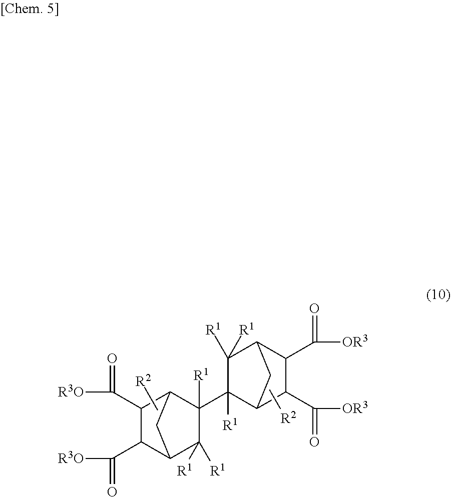

[In the formula, R¹ and R² are the same as R¹ and R² in the general formula (1), and R³s each independently represent one selected from the group consisting of an alkyl group having 1 to 10 carbon atoms, a cycloalkyl group having 3 to 10 carbon atoms, an alkenyl group having 2 to 10 carbon atoms, an aryl group having 6 to 20 carbon atoms, and an aralkyl group having 7 to 20 carbon atoms.]

When such a production method is employed, in obtaining the tetracarboxylic acid dianhydride represented by the general formula (1), at least one among the compounds represented by the general formulas (2) to (9), which are reaction intermediates, is generally mixed in at a percentage of about several percent in the product (It is considered that the reaction intermediates composed of the compounds represented by the general formulas (2) to (9) basically include the compound represented by the general formula (4) as the main component when the reaction is sufficiently progressed.). Therefore, in the present invention, the monomer (A) comprising the tetracarboxylic acid dianhydride represented by the general formula (1) may contain at least one ester compound selected from the compounds represented by the general formulas (2) to (9) in a ratio such that the total amount of the ester compounds is 5% by mass or less relative to the total amount of the compounds represented by the general formulas (1) to (9) contained in the monomer (A). Note that the monomer (A) containing ester compounds in a ratio of 5% by mass or less based on the total amount tends to be industrially easy to produce.

The ester compound that the monomer (A) may contain is one among the compounds represented by the general formulas (2) to (9), or a mixture of two or more thereof. R¹ and R² in the general formulas (2) to (9) are the same as R¹ and R² in the general formula (1) (preferable ones are also the same).

In the general formulas (2) to (9), R³s each independently represent one selected from the group consisting of an alkyl group having 1 to 10 carbon atoms, a cycloalkyl group having 3 to 10 carbon atoms, an alkenyl group having 2 to 10 carbon atoms, an aryl group having 6 to 20 carbon atoms, and an aralkyl group having 7 to 20 carbon atoms.

The alkyl group that can be selected as R³ in the general formulas (2) to (9) is an alkyl group having 1 to 10 carbon atoms. When the number of carbon atoms of such an alkyl group is 10 or less, purification tends to be easier compared to when exceeding 10 carbon atoms. From the viewpoint of easier purification, the number of carbon atoms of the alkyl group that can be selected as R³ is more preferably 1 to 5, and further preferably 1 to 3. The alkyl groups that can be selected as multiple R³s may be linear or branched.

The cycloalkyl group that can be selected as R³ in the general formulas (2) to (9) is a cycloalkyl group having 3 to 10 carbon atoms. When the number of carbon atoms of such a cycloalkyl group is 10 or less, purification tends to be easier compared to when exceeding 10 carbon atoms. From the viewpoint of easier purification, the number of carbon atoms of the cycloalkyl group that can be selected as R³ is more preferably 3 to 8, and further preferably 5 to 6.

Furthermore, the alkenyl group that can be selected as R³ in the general formulas (2) to (9) is an alkenyl group having 2 to 10 carbon atoms. When the number of carbon atoms of such an alkenyl group is 10 or less, purification tends to be easier compared to when exceeding 10 carbon atoms. From the viewpoint of easier purification, the number of carbon atoms of the alkenyl group that can be selected as R³ is more preferably 2 to 5, and further preferably 2 to 3.

The aryl group that can be selected as R³ in the general formulas (2) to (9) is an aryl group having 6 to 20 carbon atoms. When the number of carbon atoms of such an aryl group is 20 or less, purification tends to be easier compared to when exceeding 20 carbon atoms. From the viewpoint of easier purification, the number of carbon atoms of the aryl group that can be selected as R³ is more preferably 6 to 10, and further preferably 6 to 8.

The aralkyl group that can be selected as R³ in the general formulas (2) to (9) is an aralkyl group having 7 to 20 carbon atoms. When the number of carbon atoms of such an aralkyl group is 20 or less, purification tends to be easier compared to when exceeding 20 carbon atoms. From the viewpoint of easier purification, the number of carbon atoms of the aralkyl group that can be selected as R³ is more preferably 7 to 10, and further preferably 7 to 9.

Furthermore, from the viewpoint of easier purification, R³ in the general formulas (2) to (9) is each independently preferably a methyl group, an ethyl group, an n-propyl group, an isopropyl group, an n-butyl group, an isobutyl group, a sec-butyl group, a t-butyl group, a cyclohexyl group, an allyl group, a phenyl group or a benzyl group, more preferably a methyl group, an ethyl group, or an n-propyl group, further preferably a methyl group or an ethyl group, and particularly preferably a methyl group. Note that the multiple R³s in the general formulas (2) to (9) may be the same or different, but from the viewpoint of synthesis, it is more preferable that they are the same.

As such a compound (reaction intermediate) represented by the general formulas (2) to (9), each elementary reaction includes intermolecular reactions and intramolecular reactions. Considering that the intermolecular reactions generally have much slower reaction rates than the intramolecular reactions, the compound represented by the general formula (4) is considered to be the main component. Note that R¹, R², and R³ in the general formulas (2) to (9) are derived from R¹, R², and R³ in the tetraester compound (raw material compound) represented by the general formula (10) Therefore, R¹, R², and R³ in the general formula (10) are the same as R¹, R², and R³ in the aforementioned general formulas (2) to (9).

As described above, the present inventors analyzed the tetracarboxylic acid dianhydride represented by the general formula (1) obtained by employing the method described in International Publication No. WO2017/030019 and found that in producing the tetracarboxylic acid dianhydride represented by the general formula (1), the compounds (ester compounds: reaction intermediates) represented by the general formulas (2) to (9), which are reaction intermediates, were mixed in at a percentage of about several percent (for example, at a ratio of about 2 to 5% by mass). As described above, the tetracarboxylic acid dianhydride represented by the general formula (1) basically uses the tetraester compound represented by the general formula (10) as a raw material, and the specific reaction intermediates derived from the raw material compound described above are contained in the product during synthesis. Based on this finding, the present invention is developed as follows: The resulting product contains the ester compounds in a ratio such that the total amount (content) of the ester compounds is 5% by mass or less (more preferably 3% by mass or less, further preferably 2.5% by mass or less) relative to the total amount of the compounds represented by the general formulas (1) to (9) contained in the monomer (A); the present invention suitably uses, as the monomer (A), the product obtained in synthesizing the tetracarboxylic acid dianhydride represented by the general formula (1) as it is, and even when such monomer (A) is used, defines its usage amount within the specific range prescribed herein so that the effect of the present invention can be achieved. From this viewpoint, in the present invention, the monomer (A) may contain the ester compounds in an amount of 5% by mass or less relative to the total amount (summed amount) of the tetracarboxylic acid dianhydride and the ester compounds. When the content of the ester compounds is within the above range, there is a tendency that the monomer (A) can be more easily obtained by employing the method described in International Publication No. WO2017/030019.

In the present invention, the ratio of the total amount of the ester compounds to the total amount of the compounds represented by the general formulas (1) to (9) contained in the monomer (A) (the total amount of the compounds represented by the general formulas (2) to (9)) is a value measured by the following measurement method.

That is, first, 1H-NMR measurement is performed on a measurement sample of the tetracarboxylic acid dianhydride represented by the general formula (1) used for the monomer (A) (for example, a product obtained by employing the method described in International Publication No. WO2017/030019, a commercially available sample, etc.), and a ¹H-NMR spectrum is obtained. Next, the integral values of all signals in the 1H-NMR spectrum are determined. Then, the integral value of the signal of the doublet around 51.0 (signal originating from two protons among the four protons at the bridgehead position of the norbornane ring) in the 1H-NMR spectrum is determined. Next, assuming that the integral value of the signal of the doublet around 61.0 (signal originating from two protons among the four protons at the bridgehead position of the norbornane ring) is converted to 100, the total integral value A of signals originating from protons of ester groups (for example, when the ester group is a methyl ester group represented by the formula: —COOCH₃, the singlet signal around 53.5 is the signal originating from protons of the methyl ester group) is determined. Next, assuming that all of the value (total amount of signals originating from protons of ester groups) determined by the integral value A originate from (6 protons) the ester compound represented by formula (4), the following calculation formula (I) is calculated to determine the value of B:

[B (% by mass)]=(A×M_{b}×100)/(300×Mₐ) (I)

[In the formula, A represents the total integral value of signals originating from protons of ester groups when the integral value of the signal originating from two protons among the four protons at the bridgehead position of the norbornane ring is converted to 100, Mₐ represents the molecular weight value of the compound represented by the general formula (1) contained in the measurement sample (for example, the product, the commercially available sample, etc.), and M_{b} represents the molecular weight value of the compound represented by the general formula (4) contained in the measurement sample.]

Next, the obtained value of B is regarded as the residual rate of all ester compounds (reaction intermediates). Then, using the value of B (residual rate of all ester compounds) obtained by the calculation formula (I), the percentage (% by mass) of the content (total amount) of the ester compounds is obtained by calculating the following calculation formula (II):

[Content of ester compounds (% by mass)]=B/(100+B) (II)

Thus, in the present invention, ¹H-NMR measurement is performed on a measurement sample of the tetracarboxylic acid dianhydride used for the monomer (A), and the values obtained by calculating the above calculation formulas (I) and (II) using the ¹H-NMR spectrum are adopted as the ratio of the total amount of the ester compounds (total amount of the compounds represented by the general formulas (2) to (9)) to the total amount of the compounds represented by the general formulas (1) to (9) contained in the monomer (A). Note that in this calculation, the calculation is performed on the assumption that all of the value (total amount of signals originating from protons of ester groups) determined by the integral value A originate from (6 protons) the ester compound represented by the general formula (4) because the ester compound represented by the general formula (4) is the main component among the ester compound group.

Thus, when the tetracarboxylic acid dianhydride represented by the general formula (1) obtained by employing the method described in International Publication No. WO2017/030019 is used for the monomer (A), the ester compounds which are reaction intermediates are mixed into the product (resulting product) of the tetracarboxylic acid dianhydride represented by the general formula (1) as described above. Therefore, the monomer (A) contains the tetracarboxylic acid dianhydride represented by the general formula (1) and the ester compounds.

In addition to the tetracarboxylic acid dianhydride represented by the general formula (1) and the ester compounds, the monomer (A) may further contain other tetracarboxylic acid dianhydrides without impairing the effects of the present invention. Examples of such other tetracarboxylic acid dianhydrides include known tetracarboxylic acid dianhydrides that can be used for producing polyamic acids and polyimides (for example, tetracarboxylic acid dianhydrides described in paragraph [0137] of International Publication No. WO2015/163314, tetracarboxylic acid dianhydrides described in paragraph [0220] of International Publication No. WO2017/030019, and tetracarboxylic acid dianhydrides described in paragraphs [0012] to [0016] of Japanese Patent Application Publication No. 2013-105063).

### <Regarding Monomer (B)>

The monomer (B) is a monomer component comprising a diamine compound (diamine-based monomer component). The diamine is not particularly limited, and known diamine compounds that can be used for producing polyamic acids and polyimides can be appropriately used. Examples thereof include aliphatic diamines, alicyclic diamines, diamino organo siloxanes, and aromatic diamines. As the diamine compound, for example, known compounds can be appropriately used (for example, diamine compounds described in paragraphs [0017] to [0022] of Japanese Patent Application Publication No. 2013-105063, aromatic diamines described in paragraph [0211] of International Publication No. WO2017/030019, diamine compounds described in paragraphs [0089] and [0129] of International Publication No. WO2015/163314, diamine compounds described in paragraphs [0030] to [0078] of International Publication No. WO2018/159733, and the like). The diamine compound may be used alone or in combination of two or more.

These diamine compounds are preferably aromatic diamines, and it is possible to suitably use at least one aromatic diamine selected from the group consisting of 4,4′-diaminobenzanilide (abbreviation: DABAN), 4,41-diaminodiphenyl ether (abbreviation: DDE), 3,4′-diaminodiphenyl ether (abbreviation: 3,4-DDE), 2,2′-bis(trifluoromethyl)benzidine (abbreviation: TFMB), 9,9′-bis(4-aminophenyl)fluorene (abbreviation: FDA), p-diaminobenzene (abbreviation: PPD), 2,2′-dimethyl-4,41-diaminobiphenyl (abbreviation: m-tol), 3,3′-dimethyl-4,4′-diaminobiphenyl (also known as: o-tolidine), 4,4′-diphenyldiaminomethane (abbreviation: DDM), 4-aminophenyl-4-aminobenzoate (abbreviation: BAAB), 4,4′-bis(4-aminobenzamide)-3,3′-dihydroxybiphenyl (abbreviation: BABB), 3,3′-diaminodiphenyl sulfone (abbreviation: 3,3′-DDS), 1,3-bis(3-aminophenoxy)benzene (abbreviation: APB-N), 1,3-bis(4-aminophenoxy)benzene (abbreviation: TPE-R), 1,4-bis(4-aminophenoxy)benzene (abbreviation: TPE-Q), 4,4′-bis(4-aminophenoxy)biphenyl (abbreviation: 4-APBP), 4,4″-diamino-p-terphenyl, bis[4-(4-aminophenoxy)phenyl]sulfone (abbreviation: BAPS), bis[4-(3-aminophenoxy)phenyl]sulfone (abbreviation: BAPS-M), 2,2′-bis[4-(4-aminophenoxy)phenyl]propane (abbreviation: BAPP), 2,2-bis[4-(4-aminophenoxy)phenyl]hexafluoropropane (abbreviation: HFBAPP), bis[4-(4-aminophenoxy)phenyl]ketone (abbreviation: BAPK), 4,4′-diaminodiphenyl sulfone (abbreviation: 4,4′-DDS), (2-phenyl-4-aminophenyl)-4-aminobenzoate (4-PHBAAB), 4,4″-diamino-p-terphenyl (abbreviation: Terphenyl), bis(4-aminophenyl) sulfide (abbreviation: ASD), bis aniline M, bis aniline P, 2,2′″-diamino-p-quarterphenyl, 2,3′″-diamino-p-quarterphenyl, 2,4′″-diamino-p-quarterphenyl, 3,3′″-diamino-p-quarterphenyl, 3,4′″-diamino-p-quarterphenyl, 4,4′″-diamino-p-quarterphenyl, 2,6-diaminonaphthalene, 1,5-diaminonaphthalene, and 1,4-diaminonaphthalene.

### <Regarding Polyimide>

The polyimide of the present invention is a polycondensate of the monomer (A) and the monomer (B), wherein the content ratio of the monomer (A) is 100.2 moles to 105 moles relative to 100 moles of the monomer (B).

In general, a polyimide is obtained whereby a tetracarboxylic acid dianhydride and a diamine compound are subjected to a ring-opening addition reaction to form a polyamic acid which is a polyaddition product thereof (addition polymer, open-ring addition polymer), and then the resulting polyamic acid is subjected to ring-closing condensation (dehydration ring closure: intramolecular condensation). Therefore, it can be said that the polymer obtained by polycondensing the monomer (A) comprising the tetracarboxylic acid dianhydride and the monomer (B) comprising the diamine compound is a polyimide.

In the present invention, the content ratio of the monomer (A) is 100.2 moles to 105 moles (more preferably 100.2 moles to 104 moles, further preferably 100.2 moles to 103 moles, and particularly preferably 100.2 moles to 102 moles) relative to 100 moles of the monomer (B) (note that the content ratio of the monomer (A) is the content ratio when the molar amount of the monomer (B) is converted to 100 moles). When the content ratio of the monomer (A) is the lower limit or more, higher heat resistance can be achieved compared to when it is less than the lower limit. On the other hand, when it is the upper limit or less, higher mechanical properties can be achieved compared to when exceeding the upper limit. When the monomer (A) contains the ester compounds (the compounds represented by the general formulas (2) to (9)), after determining the total amount of the ester compounds as described above, the molar amount of the ester compounds contained in the monomer (A) is calculated on the basis of that value, assuming that all of the ester compounds are the compound represented by the general formula (4). Note that since higher effects in terms of heat resistance can be achieved, the lower limit value of the content ratio of the monomer (A) is more preferably 100.5 moles.

In the present invention, while the monomer (A) is used such that the content ratio of the monomer (A) is set to 100.2 moles to 105 moles relative to 100 moles of the monomer (B). Here, the present inventors presume as follows. In particular, when the monomer (A) contains the ester compound as a reaction intermediate, the usage amount of the monomer (A) is increased to be within the above range in consideration of the content of the reaction intermediate; thereby, it is possible to separately contain a small amount of the ester compound as the reaction intermediate while setting the molar ratio of the tetracarboxylic acid dianhydride to the diamine compound to the theoretical amount (1:1), for example. This makes it possible not only to efficiently react the compounds with each other, and also to introduce an ester group derived from the ester compound at the terminus of the polymer. Since the terminus slightly increases in bulkiness accordingly, the free volume of the resulting polyimide decreases, making it possible to further improve the glass transition temperature (Tg). This allows obtaining even higher heat resistance.

The polyimide can also have a repeating unit (I) represented by the following general formula (20) formed by the reaction of the tetracarboxylic acid dianhydride represented by the general formula (1) and the diamine compound:

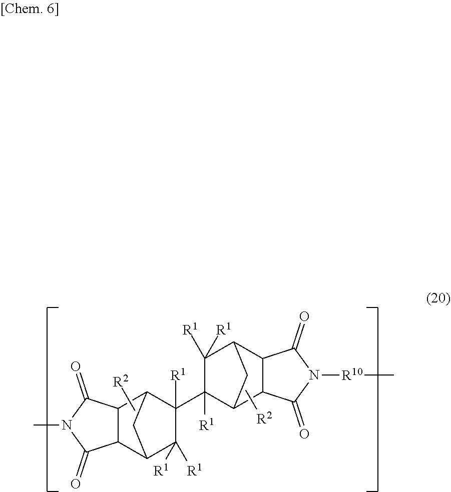

[In the formula, R¹ and R² are the same as R¹ and R² in the general formula (1) (preferable ones are also the same), and R¹⁰ is a residue (divalent group) obtained by removing two amino groups from the diamine compound (preferably an aromatic diamine).]

Note that the site represented by the formula: —R¹⁰— in the repeating unit (I) is a divalent group (residue) remaining after removing the sites of two amino groups (NH₂) when the diamine compound used for producing the polyimide is represented by the formula: H₂N—R¹⁰—NH₂.

When the polyimide of the present invention has the repeating unit (I), the content of the repeating unit (I) is not particularly limited, but is preferably 80 to 100% by mole, more preferably 90 to 100% by mole, relative to all repeating units in the polyimide. By setting the content of the repeating unit (I) to the lower limit or more, the heat resistance of the resulting polyimide can be improved compared to when it is less than the lower limit.

It is preferable that the polyimide of the present invention has sufficiently high transparency when formed into a film, and one having a total light transmittance of 80% or more (further preferably 85% or more, particularly preferably 90% or more) is more preferable. Such a polyimide is preferably one having a haze of 5 to 0 (further preferably 4 to 0, particularly preferably 3 to 0). Such a polyimide is preferably one having a yellowness index (YI) of 5 to −2 (further preferably 4 to −2, particularly preferably 3 to −2). Note that such a total light transmittance can be determined by measurement in accordance with JIS K7361-1 (issued in 1997), such a haze can be determined by measurement in accordance with JIS K7136 (issued in 2000), and such a yellowness index (YI) can be determined by measurement in accordance with ASTM E313-05 (issued in 2005).

From the viewpoint of conferring the polyimide with sufficiently high heat resistance, the polyimide of the present invention more preferably has a glass transition temperature (Tg) of 300° C. to 550° C., and further preferably 350° C. to 550° C. Such a glass transition temperature (Tg) can be measured in tensile mode using a thermomechanical analyzer (trade name “TMA8311” manufactured by Rigaku Corporation).

The polyimide of the present invention preferably has a 5% weight loss temperature of 450° C. or higher, and more preferably 450° C. to 550° C. The number average molecular weight (Mn) of such a polyimide is preferably 1000 to 1000000, and more preferably 10000 to 500000, in terms of polystyrene. The weight average molecular weight (Mw) of such a polyimide is preferably 1000 to 5000000, more preferably 5000 to 5000000, and further preferably 10000 to 500000, in terms of polystyrene. Furthermore, the molecular weight distribution (Mw/Mn) of such a polyimide is preferably 1.1 to 5.0, and more preferably 1.5 to 3.0. Note that such molecular weight (Mw or Mn) and molecular weight distribution (Mw/Mn) of the polyimide can be obtained by converting to polystyrene based on data obtained by gel permeation chromatography (GPC). For such a polyimide, when it is difficult to measure the molecular weight, the molecular weight and the like may be inferred based on the viscosity of the polyamic acid used for producing the polyimide and selected as appropriate for applications.

Such a polyimide can be produced by the same method as the known method (for example, the method described in International Publication No. WO2017/030019) except that the monomer (A) and the monomer (B) are used in the specific molar ratio.

The polyimide of the present invention may further contain additive components such as antioxidants, ultraviolet absorbers, hindered amine-based light stabilizers, nucleating agents, clarifying agents, inorganic fillers (such as glass fibers, glass hollow spheres, talc, mica, alumina, titania, and silica), heavy metal deactivators, additives for filler-filled plastics, flame retardants, processing aids, lubricants/water-dispersible stabilizers, permanent antistatic agents, toughness improvers, surfactants, and carbon fibers, depending on the application.

The shape of such a polyimide is not particularly limited. For example, it may be made into a film shape or powdered, or may be made into a pellet shape by extrusion molding. Thus, the polyimide of the present invention can also be appropriately molded into various shapes by known methods, such as making it into a film shape or a pellet shape by extrusion molding.

Such a polyimide can be used for various applications. For example, it is particularly useful as a material for manufacturing flexible wiring board films, heat-resistant insulating tapes, electric wire enamels, protective coating agents for semiconductors, liquid crystal alignment films, transparent conductive films for organic EL, flexible substrate films, flexible transparent conductive films, transparent conductive films for organic thin-film solar cells, transparent conductive films for dye-sensitized solar cells, flexible gas barrier films, touch panel films, TFT substrate films for flat panel detectors, seamless polyimide belts for copiers (so-called transfer belts), transparent electrode substrates (transparent electrode substrates for organic EL, transparent electrode substrates for solar cells, transparent electrode substrates for electronic paper, and the like), interlayer insulating films, sensor substrates, image sensor substrates, light emitting diode (LED) reflectors (LED lighting reflectors), LED lighting covers, covers for LED reflector lighting, cover lay films, highly ductile complex substrates, resists for semiconductors, lithium ion batteries, substrates for organic memories, substrates for organic transistors, substrates for organic semiconductors, color filter substrates, and the like.

### [Polyimide Precursor]

The polyimide precursor of the present invention is a polyaddition product of a monomer (A) comprising a tetracarboxylic acid dianhydride represented by the general formula (1) and a monomer (B) comprising a diamine compound, wherein the content ratio of the monomer (A) is 100.2 moles to 105 moles relative to 100 moles of the monomer (B).

In the present invention, the tetracarboxylic acid dianhydride represented by the general formula (1), the monomer (A), and the monomer (B) are the same as those described for the polyimide of the present invention (their preferable ones are also the same). The range of the content ratio of the monomer (A) and its preferable range are also the same as those described for the polyimide of the present invention.

The polyimide precursor of the present invention is the polyaddition product of the monomer (A) and the monomer (B). Such a polyimide precursor may be a polyamic acid obtained by an addition reaction of the monomer (A) and the monomer (B), or may be a derivative of the polyamic acid. Since the polyimide precursor is obtained by an addition reaction of the tetracarboxylic acid dianhydride represented by the general formula (1) and the diamine compound, it can have repeating unit (II) represented by the following general formula (21):

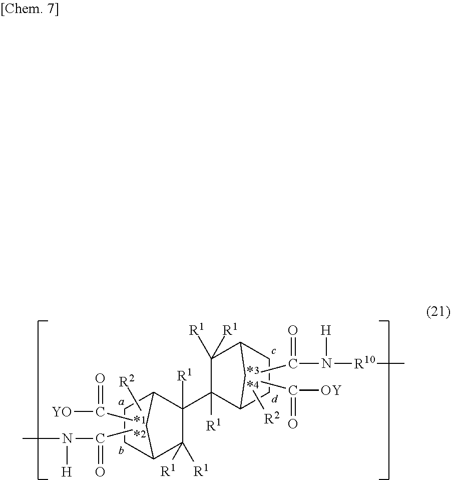

[In the formula, R¹ and R² are the same as R¹ and R² in the general formula (1) (preferable ones are also the same), R¹⁰ is a residue (divalent group) obtained by removing two amino groups from the diamine compound (preferably an aromatic diamine), Y each independently represents one selected from the group consisting of a hydrogen atom, an alkyl group having 1 to 6 carbon atoms, and an alkylsilyl group having 3 to 9 carbon atoms. One of the bonds represented by *1 and *2 binds to carbon atom a forming the norbornane ring, the other of the bonds represented by *1 and *2 binds to carbon atom b forming the norbornane ring, one of the bonds represented by *3 and *4 binds to carbon atom c forming the norbornane ring, and the other of the bonds represented by *3 and *4 binds to carbon atom d forming the norbornane ring.]

Note that the site represented by the formula: —R¹⁰— in the repeating unit (II) is a divalent group (residue) remaining after removing the sites of two amino groups (NH₂) when the diamine compound used for producing the polyimide precursor is represented by the formula: H₂N—R¹⁰—NH₂.

In the general formula (21), Y each independently represents one selected from the group consisting of a hydrogen atom, an alkyl group having 1 to 6 (preferably 1 to 3) carbon atoms, and an alkylsilyl group having 3 to 9 carbon atoms. Such Y can be varied by appropriately changing the production conditions in terms of the type of substituent and the rate of introduction of the substituent. When all Y are hydrogen atoms (when it is a repeating unit of so-called polyamic acid), there is a tendency that production of polyimide becomes easier. From this viewpoint, it is preferable that the polyimide precursor is a polyamic acid.

When Y in the general formula (21) is an alkyl group having 1 to 6 (preferably 1 to 3) carbon atoms, the storage stability of the polyimide precursor tends to be superior. Also, when Y is an alkyl group having 1 to 6 (preferably 1 to 3) carbon atoms, it is more preferable that Y is a methyl group or an ethyl group. When Y in the general formula (21) is an alkylsilyl group having 3 to 9 carbon atoms, the solubility of the polyimide precursor tends to be superior. Also, when Y is an alkylsilyl group having 3 to 9 carbon atoms, it is more preferable that Y is a trimethylsilyl group or a t-butyldimethylsilyl group.

Regarding Y in the repeating unit (II), the rate of introduction of groups other than hydrogen atoms (alkyl groups and/or alkylsilyl groups) is not particularly limited. However, in the case where at least some of Y in the formula are alkyl groups and/or alkylsilyl groups, it is preferable that 25% or more (more preferably 50% or more, further preferably 75% or more) of the total amount of Y in the repeating unit (I) are alkyl groups and/or alkylsilyl groups (in this case, Y other than the alkyl group and/or alkylsilyl group is a hydrogen atom). By adjusting such that 25% or more of the total amount of each Y in the repeating unit (II) is composed of alkyl groups and/or alkylsilyl groups, the storage stability of the polyimide precursor tends to be superior.

When the polyimide precursor of the present invention has the repeating unit (II), the content of the repeating unit (II) is not particularly limited, but is preferably 80 to 100% by mole, and more preferably 90 to 100% by mole, relative to all repeating units in the polyimide precursor. By setting the content of the repeating unit (II) to the lower limit or more, it is possible to improve the heat resistance of the polyimide obtained by using the polyimide precursor compared to when it is less than the lower limit.

The logarithmic viscosity pint of such a polyimide precursor (preferably polyamic acid) is preferably 0.05 to 3.0 dL/g, and more preferably 0.1 to 2.0 dL/g. When the logarithmic viscosity pint is less than 0.05 dL/g, there is a tendency that a film obtained by producing a film-shaped polyimide using this becomes brittle. On the other hand, when it exceeds 3.0 dL/g, the viscosity becomes too high and the processability decreases, making it difficult to obtain a uniform film when producing a film, for example. As such a logarithmic viscosity ηint, a value obtained by preparing a measurement sample (solution) by dissolving the polyamic acid in N,N-dimethylacetamide so that the concentration is 0.5 g/dL, and measuring the viscosity of the measurement sample at a temperature condition of 30° C. using a kinematic viscosity meter is employed. As such a kinematic viscosity meter, an automatic viscometer manufactured by Cannon Instrument Company (trade name “MINI Series Model PV—HX”) can be used.

As a method for producing the polyimide precursor resin of the present invention, the same method as the method for producing polyimide (for example, the method described in International Publication No. WO2017/030019) can be employed except that the monomer (A) and the monomer (B) are used in the specific molar ratio. In order to produce a polyimide precursor containing the repeating unit (II) in which Y is other than a hydrogen atom in the general formula (21), for example, except that the tetracarboxylic acid dianhydride represented by the general formula (1) is used as the tetracarboxylic acid dianhydride, the method described in paragraphs [0165] to [0174] of International Publication No. WO2018/066522 can be appropriately employed.

Note that the polyimide precursor (preferably polyamic acid) of the present invention may be contained in an organic solvent and used as a resin solution of the polyimide precursor (varnish). The content of the polyimide precursor in such a resin solution is not particularly limited, but is preferably 1 to 80% by mass, and more preferably 5 to 50% by mass. Note that such a resin solution of the polyimide precursor can be suitably used as a resin solution (varnish) for producing the polyimide of the present invention and can be suitably used for producing polyimides of various shapes. For example, by applying such a resin solution of the polyimide precursor onto various substrates and imidizing it for curing, a film-shaped polyimide can be easily produced. The organic solvent used for such a resin solution (varnish) is not particularly limited, and known ones can be appropriately used. For example, solvents described in paragraph [0175] and paragraphs [0133] and [0134] of International Publication No. WO2018/066522 can be appropriately used.

### EXAMPLES

Hereinafter, the present invention will be described more specifically based on Examples and Comparative Examples, but the present invention is not limited to the following Examples.

### <Method for Evaluating Characteristics of Polymers Obtained in Each of Examples and the Like>

First, the method for evaluating the characteristics of the polyamic acids and polyimides obtained in each of the Examples and the like will be described. Note that the evaluation results obtained by employing the following evaluation methods are shown in Table 1.

### <Method for Measuring Logarithmic Viscosity Pint of Polyamic Acid>

The logarithmic viscosity pint of the polyamic acid in the reaction solution obtained in each of Examples and the like was determined by sampling the polyamic acid from the reaction solution, preparing as a measurement sample a 0.5 g/dL polyamic acid solution with N,N-dimethylacetamide as a solvent, and using an automatic viscometer manufactured by Cannon Instrument Company (trade name “MINI Series Model PV—HX”) as a measuring device to measure under the temperature condition of 30° C.

### <Method for Measuring Glass Transition Temperature (Tg) of Polyimide>

The glass transition temperature (Tg) (unit: ° C.) was determined by cutting out a film having a size of 20 mm in length and 5 mm in width from the polyimide (film) obtained in each of Examples and the like as a measurement sample (the thickness of the sample was kept the same as the thickness of the film obtained in each of Examples and the like), using a thermomechanical analyzer (trade name “TMA8311” manufactured by Rigaku Corporation) as a measuring device, and measuring in tensile mode (49 mN) under a nitrogen atmosphere at a temperature rise rate of 5° C./min to obtain a TMA curve, and extrapolating the curves before and after the inflection point of the TMA curve due to glass transition, thereby determining the value (unit: ° C.) of the glass transition temperature (Tg) of the resin constituting the film obtained in each of Examples and the like.

### <Method for Measuring Total Light Transmittance of Polyimide>

The total light transmittance (unit: %) was determined by using the polyimide (film) obtained in each of Examples and the like directly as a sample for measurement and using a haze meter trade named “NDH-5000” manufactured by Nippon Denshoku Industries Co., Ltd. as a measuring device to perform measurement in accordance with JIS K7361-1 (issued in 1997).

### <Method for Measuring Coefficient of Linear Thermal Expansion (CTE) of Polyimide>

The coefficient of linear thermal expansion (CTE) (unit: ppm/K) was determined by cutting out a film having a size of 20 mm in length and 5 mm in width (the thickness was kept the same as the thickness of the film obtained in each of Examples and the like) from the polyimide (film) obtained in each of Examples and the like as a measurement sample, using a thermomechanical analyzer (trade name “TMA8311” manufactured by Rigaku Corporation) as a measuring device, adopting conditions of a nitrogen atmosphere, tensile mode (49 mN), and a temperature rise rate of 5° C./min, measuring the change in length of the sample at 50° C. to 200° C., and calculating an average value of the change in length per 1° C. in the temperature range of 100° C. to 200° C.

### Example 1

### <Step (1) of Synthesizing BNBDA>

Using the tetramethyl ester compound represented by the following formula (30):

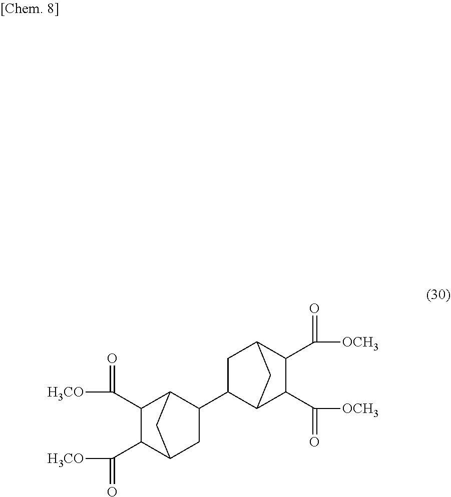 [SMILES: COC(=O)C1C2CC(C3CC4CC3C(C(=O)OC)C4C(=O)OC)C(C2)C1C(=O)OC]

as a raw material compound, the compound (BNBDA) represented by the following formula (31):

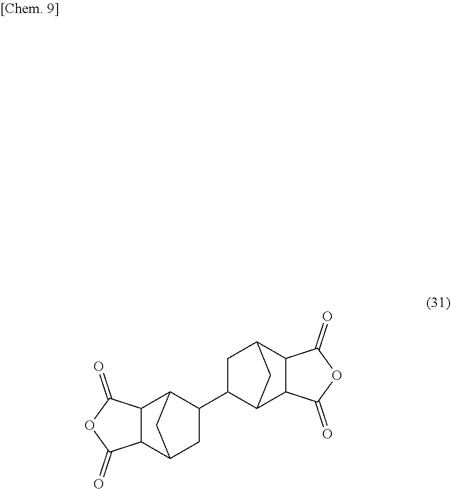 [SMILES: O=C1OC(=O)C2C3CC(CC3C3CC4CC3C3C(=O)OC(=O)C43)C12]

was synthesized according to the method described in International Publication No. WO2017/030019, and the resulting product (synthetic product containing BNBDA and reaction intermediates) was used as it was as a monomer (A) comprising BNBDA.

Note that the total amount of the ester compound as a reaction intermediate contained in the product (the ester compound is at least one among the compounds represented by the general formulas (2) to (9) from the type of the raw material compound, each R¹ and each R² in the formulas is hydrogen atom, and each R³ in the formula is methyl group) was measured as follows. That is, first, 1H-NMR measurement was performed on the product, and the integral values of all signals in the ¹H-NMR spectrum were determined. Next, assuming that the integral value of the signal of the doublet around 51.0 (signal originating from two protons among the four protons at the bridgehead position of the norbornane ring) in the 1H-NMR spectrum is 100, the integral value A of the singlet signal around 53.5 was calculated (the singlet signal around 53.5 is the signal originating from protons of the methyl ester group of the ester compound). Then, assuming that the value determined as integral value A (total amount of signals originating from protons of methyl ester groups) originates from (6 protons) the ester compound represented by the general formula (4), in which each R¹ and each R² in the formula is hydrogen atom and each R³ in the formula is methyl group (hereinafter, the compound may be simply referred to as “half ester”), the following calculation formula (1) was calculated to determine the value of the residual rate B of the half ester:

[B (% by mass)]=(A×376×100)/(300×330) (1).

(Note that, in such formula (1), 376 represents the molecular weight value of the half ester, 330 represents the molecular weight value of BNBDA, and A represents the value of integral value A.)

The obtained value of the residual rate B of the half ester was regarded as the residual rate of all ester compounds contained in the product, and the content (total amount) of the ester compounds (compounds represented by the general formulas (2) to (9)) contained in the product was obtained by calculating the following calculation formula (2):

[Content of ester compounds (% by mass)]=B/(100+B) (2).

As a result of such measurement, the total amount of the ester compounds contained in the product was 2.21% by mass. Hereinafter, for convenience, the product obtained by using “Step (1) of synthesizing BNBDA” (synthetic product containing BNBDA and reaction intermediates) is simply referred to as “BNBDA (I).”

### <Step of Preparing Polyamic Acid>

First, under a nitrogen atmosphere, in a 30 mL screw tube, 2.00 g (10.0 mmol) of 4,4′-diaminodiphenylamine (4,4′-DDE) was introduced as monomer (B), and BNBDA(I) (content of ester compound: 2.21% by mass) at 3.37 g (10.2 mmol (BNBDA: 10 mmol and the ester compound (reaction intermediate): 0.2 mmol)) was introduced as monomer (A).

Then, 21.5 g of dimethylacetamide (N,N-dimethylacetamide) was added to the screw tube to obtain a mixed solution. Next, the resulting mixed solution was stirred for 3 hours under a nitrogen atmosphere at room temperature (25° C.) to produce a polyamic acid, thereby obtaining a reaction solution containing the polyamic acid (polyamic acid solution). The logarithmic viscosity of the obtained polyamic acid was 0.733 dL/g. Note that the molar ratio of monomers (A) and (B) used for producing the polyamic acid [(A):(B)] was 102:100.

### <Step of Preparing Polyimide>

A large slide glass (trade name “S9213” manufactured by Matsunami Glass Ind., Ltd., vertical: 76 mm, horizontal: 52 mm, thickness: 1.3 mm) was prepared as a glass substrate, and the reaction solution obtained as described above (polyamic acid solution) was spin-coated on the surface of the glass substrate to form a coating film on the glass substrate. Then, the glass substrate with a coating film formed thereon was dried under vacuum at 70° C. for 30 minutes (drying step). Next, the glass substrate with a coating film formed thereon was placed in an inert oven, heated under a nitrogen atmosphere from room temperature to 350° C. and held for 1 hour to cure the coating film. In this way, a polyimide-coated glass coated with a polyimide thin film (polyimide film) on the glass substrate was obtained.

Next, the polyimide-coated glass obtained in this manner was immersed in hot water at 90° C. to peel off the film from the glass substrate, thereby obtaining a polyimide film (film having a size of vertical 76 mm, horizontal 52 mm, and thickness 13 μm).

### Comparative Example 1

### <Step (2) of Synthesizing BNBDA>

Using the tetramethyl ester compound represented by the formula (30) as a raw material, the compound (BNBDA) represented by the formula (31) was synthesized according to the method described in International Publication No. WO2017/030019 (however, the scale during synthesis was made 1/10 compared to the step of synthesizing BNBDA adopted in Example 1), and the resulting product (synthetic product containing BNBDA and reaction intermediates) was used as it was as monomer (A) comprising BNBDA. Note that when the total amount of ester compounds (at least one among the compounds represented by the general formulas (2) to (9), each R¹ and each R² in the formulas is hydrogen atom, and each R³ in the formula is methyl group) contained in the product was measured in the same manner as in Example 1, the total amount of ester compounds contained in the resulting product was 2.16% by mass. Hereinafter, for convenience, the product obtained by “Step (2) of synthesizing BNBDA” (synthetic product containing BNBDA and reaction intermediates) is simply referred to as “BNBDA (II).”

### <Step of Preparing Polyamic Acid>

Under a nitrogen atmosphere, in a 30 mL screw tube, 0.74 g (3.7 mmol) of 4,4′-diaminodiphenylamine (4,4′-DDE) was introduced as monomer (B), and BNBDA(II) (content of ester compound: 2.16% by mass) at 1.22 g (3.7 mmol (BNBDA: 3.62 mmol and the ester compound (reaction intermediate): 0.07 mmol)) was introduced as monomer (A). Then, 7.84 g of dimethylacetamide (N,N-dimethylacetamide) was added to the screw tube to obtain a mixed solution. Next, the resulting mixed solution was stirred for 3 hours under a nitrogen atmosphere at 80° C. to produce a polyamic acid, thereby obtaining a comparative reaction solution containing the polyamic acid (comparative polyamic acid solution). The logarithmic viscosity of the obtained polyamic acid was 0.582 dL/g. Note that the molar ratio of monomers (A) and (B) used for producing the polyamic acid [(A):(B)] was 100:100.

### <Step of Preparing Polyimide>

A polyimide film was obtained by adopting the same step as the step of preparing polyimide adopted in Example 1 except that the comparative reaction solution obtained as described above was used, the step of drying the glass substrate with the formed coating film under vacuum was not performed and, as the heating condition in the inert oven, the condition of heating from room temperature to 70° C. and maintaining for 2 hours, and then heating from 70° C. to 350° C. and maintaining for 1 hour was adopted instead of adopting the condition of heating from room temperature to 350° C. and maintaining for 1 hour.

### Example 2

### <Step of Preparing Polyamic Acid>

Under a nitrogen atmosphere, in a 30 mL screw tube, a diamine mixture containing 1.14 g (5.0 mmol) of 4,41-diaminodiphenylamine (4,4′-DDE) and 1.00 g (5.0 mmol) of 4,4′-diaminobenzanilide (DABAN) was introduced as monomer (B). In addition, BNBDA(I) (content of ester compound: 2.21% by mass) at 3.37 g (10.2 mmol (BNBDA: 10 mmol and the ester compound (reaction intermediate): 0.2 mmol)) was introduced as monomer (A). Then, 22 g of tetramethylurea was added to the screw tube to obtain a mixed solution. Next, the resulting mixed solution was stirred for 3 hours under a nitrogen atmosphere at room temperature (25° C.) to produce a polyamic acid, thereby obtaining a reaction solution containing the polyamic acid (polyamic acid solution). The logarithmic viscosity of the obtained polyamic acid was 0.648 dL/g. Note that the molar ratio of monomers (A) and (B) used for producing the polyamic acid [(A):(B)] was 102:100.

### <Step of Preparing Polyimide>

A polyimide film was obtained by adopting the same step as the step of preparing polyimide adopted in Example 1 except that the reaction solution obtained in this manner was used, the drying time in the drying step was changed from 30 minutes to 1 hour, and, as the heating condition in the inert oven, the condition of heating from room temperature to 135° C. and maintaining for 30 minutes, and then heating from 135° C. to 350° C. and maintaining for 1 hour was adopted instead of adopting the condition of heating from room temperature to 350° C. and maintaining for 1 hour.

### Comparative Example 2

### <Step of Preparing Polyamic Acid>

Under a nitrogen atmosphere, in a 30 mL screw tube, a diamine mixture containing 1.00 g (5.0 mmol) of 4,4′-diaminodiphenylamine (4,4′-DDE) and 1.14 g (5.0 mmol) of 4,4′-diaminobenzanilide (DABAN) was introduced as monomer (B). In addition, BNBDA(II) (content of ester compound: 2.16% by mass) at 3.30 g (10.0 mmol (BNBDA: 9.78 mmol and the ester compound (reaction intermediate): 0.19 mmol)) was introduced as monomer (A). Then, 21.8 g of dimethylacetamide (N,N-dimethylacetamide) was added to the screw tube to obtain a mixed solution. Next, the resulting mixed solution was stirred for 3 hours under a nitrogen atmosphere at 60° C. to produce a polyamic acid, thereby obtaining a comparative reaction solution containing the polyamic acid (comparative polyamic acid solution). The logarithmic viscosity of the obtained polyamic acid was 0.563 dL/g. Note that the molar ratio of monomers (A) and (B) used for producing the polyamic acid [(A):(B)] was 100:100.

### <Step of Preparing Polyimide>

A polyimide film was obtained by adopting the same step as the step of preparing polyimide adopted in Example 1 except that the comparative reaction solution (polyamic acid solution) obtained as described above was used, the step of drying the glass substrate with the formed coating film under vacuum was not performed and, as the heating condition in the inert oven, the condition of heating from room temperature to 60° C. and maintaining for 4 hours, and then heating from 60° C. to 350° C. and maintaining for 1 hour was adopted instead of adopting the condition of heating from room temperature to 350° C. and maintaining for 1 hour.

### Example 3

### <Step of Preparing Polyamic Acid>

Under a nitrogen atmosphere, in a 30 mL screw tube, 1.84 g (5.0 mmol) of 4,4′-bis(4-aminophenoxy)biphenyl (APBP) was introduced as monomer (B), and BNBDA(I) (content of ester compound: 2.21% by mass) at 1.68 g (5.1 mmol (BNBDA: 4.99 mmol and the ester compound (reaction intermediate): 0.1 mmol)) was introduced as monomer (A). Then, 14.1 g of dimethylacetamide (N,N-dimethylacetamide) was added to the screw tube to obtain a mixed solution. Next, the resulting mixed solution was stirred for 3 days under a nitrogen atmosphere at room temperature (25° C.) to produce a polyamic acid, thereby obtaining a reaction solution containing the polyamic acid (polyamic acid solution). The logarithmic viscosity of the obtained polyamic acid was 0.731 dL/g. Note that the molar ratio of monomers (A) and (B) used for producing the polyamic acid [(A):(B)] was 102:100.

### <Step of Preparing Polyimide>

A polyimide film was obtained by adopting the same step as the step of preparing polyimide adopted in Example 1 except that the reaction solution (polyamic acid solution) obtained in this manner was used and the temperature condition during heating in the inert oven was changed from 350° C. to 300° C.

### Comparative Example 3

### <Step of Preparing Polyamic Acid>

Under a nitrogen atmosphere, in a 30 mL screw tube, 1.02 g (2.77 mmol) of 4,4′-bis(4-aminophenoxy)biphenyl (APBP) was introduced as monomer (B), and BNBDA(II) (content of ester compound: 2.16% by mass) at 0.91 g (2.76 mmol (BNBDA: 2.71 mmol and the ester compound (reaction intermediate): 0.05 mmol)) was introduced as monomer (A). Then, 7.98 g of dimethylacetamide (N,N-dimethylacetamide) was added to the screw tube to obtain a mixed solution. Next, the resulting mixed solution was stirred for 3 hours under a nitrogen atmosphere at 70° C. to produce a polyamic acid, thereby obtaining a reaction solution containing the polyamic acid (polyamic acid solution). The logarithmic viscosity of the obtained polyamic acid was 0.564 dL/g. Note that the molar ratio of monomers (A) and (B) used for producing the polyamic acid [(A):(B)] was 100:100.

### <Step of Preparing Polyimide>

A polyimide film was obtained by adopting the same step as the step of preparing polyimide adopted in Example 1 except that the temperature condition in the drying step was changed from 70° C. to 60° C. and the temperature condition during heating in the inert oven was changed from 350° C. to 300° C.

TABLE 1

| | | | Comparative | | Comparative | | Comparative |
|---|---|---|---|---|---|---|---|
| | | Example 1 | Example 1 | Example 2 | Example 2 | Example 3 | Example 3 |
| Monomers | Monomer (A) | BNBDA (I) | BNBDA (I) | BNBDA (I) | BNBDA (I) | BNBDA (I) | BNBDA (I) |
| | Monomer (B)*¹ | DDE | DDE | DDE(50) | DDE (50) | APBP | APBP |
| | | | | DABAN (50) | DABAN (50) | | |
| | Monomer Molar Ratio | 102:100 | 100:100 | 102:100 | 100:100 | 102:100 | 100:100 |
| | [Monomer (A)]:[Monomer (B)] | | | | | | |
| | Content of Ester Compounds*² | 2.21 | 2.16 | 2.21 | 2.16 | 2.21 | 2.16 |
| | [mass %] | | | | | | |
| Logarithmic Viscosity ηint | | 0.733 | 0.582 | 0.648 | 0.563 | 0.731 | 0.564 |
| of Polyamic Acid | | | | | | | |
| [dL/g] | | | | | | | |
| Properties | Film Thickness | 13 | 12 | 13 | 17 | 13 | 11 |
| of Polyimide | [μm] | | | | | | |
| | Glass Transition Temperature (Tg) | 409 | 379 | 403 | 356 | 425 | 379 |
| | [° C.] | | | | | | |
| | Total Light Transmittance | 88 | 89 | 87 | 86 | 88 | 85 |
| | [%] | | | | | | |
| | Coefficient of Linear Thermal | 52 | 61 | 43 | 43 | 51 | 67 |
| | Expansion (CTE) | | | | | | |
| | [ppm/K] | | | | | | |

*¹The bracketed values for DDE and DABAN in Example 2 and Comparative Example 2 indicate the molar ratios of DDE and DABAN.
*²Content of Ester Compounds indicates the content of ester compounds relative to the total amount of BNBDA and ester compounds in monomer (A).

As is clear from the results shown in Table 1, when the polyimides obtained in Examples 1 to 3 and Comparative Examples 1 to 3 are compared between those having the same type of monomer (B), the polyimides obtained in Examples 1 to 3, in which the ratio of monomers (A) and (B) is within the range specified in the present invention, have higher Tg values than the polyimides obtained in Comparative Examples 1 to 3, and thereby it is confirmed that the heat resistance based on Tg is at a higher level. The polyimides obtained in Examples 1 to 3 and Comparative Examples 1 to 3 all have a total light transmittance of 80% or more, demonstrating a high level of light transmittance. Furthermore, when the polyimides obtained in Examples 1 to 3 and Comparative Examples 1 to 3 are compared between those having the same type of monomer (B), the polyimides obtained in Examples 1 to 3, in which the ratio of monomers (A) and (B) is within the range specified in the present invention, have CTE values equal to or lower than those of the polyimides obtained in Comparative Examples 1 to 3.

### INDUSTRIAL APPLICABILITY

As described above, according to the present invention, it is possible to provide a polyimide capable of achieving a higher level of heat resistance while having a high level of light transmittance, and a polyimide precursor suitably usable for producing the polyimide. Thus the polyimide of the present invention has excellent heat resistance and transparency, and therefore is particularly useful as a material for producing resin substrates used as substitutes for glass substrates, various resin films (e.g. films for flexible wiring boards, flexible substrate films, etc.), and the like.

1. A polyimide which is a polycondensate of a monomer (A) comprising a tetracarboxylic acid dianhydride represented by the following general formula (1): 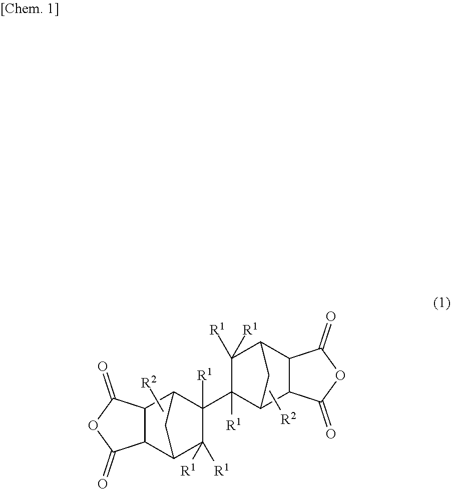
[In formula (1), R¹s each independently represent one selected from the group consisting of a hydrogen atom, an alkyl group having 1 to 10 carbon atoms, a hydroxy group, and a nitro group, or two R¹s bonded to the same carbon atom may together form a methylene group, and
R²s each independently represent one selected from the group consisting of a hydrogen atom and an alkyl group having 1 to 10 carbon atoms.]
and a monomer (B) comprising a diamine compound, wherein
a content ratio of the monomer (A) is 100.2 moles to 105 moles relative to 100 moles of the monomer (B).

2. The polyimide according to claim 1, wherein the monomer (A) contains at least one ester compound selected from compounds represented by the following general formulas (2) to (9): 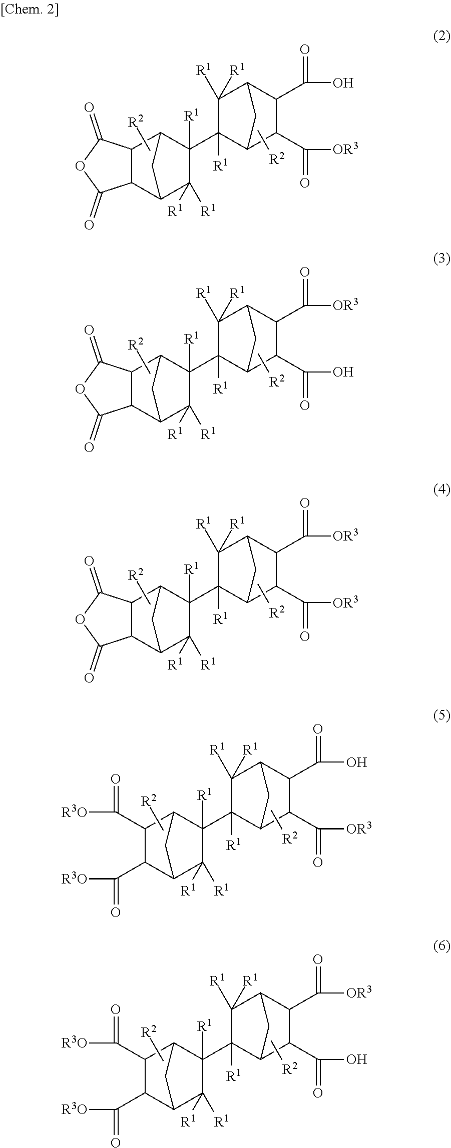 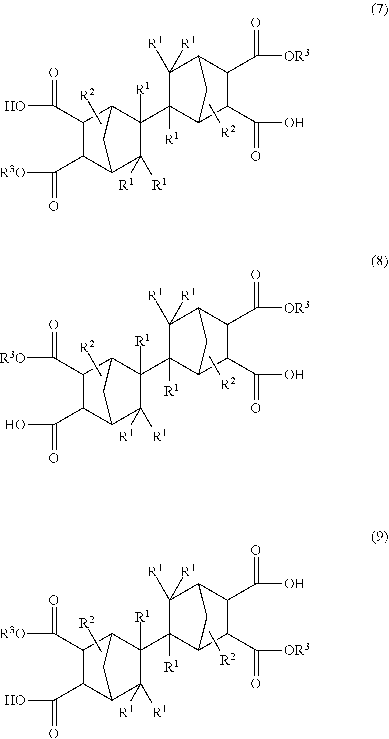
[In formulas (2) to (9), R¹ and R² are the same as R¹ and R² in the general formula (1), and R³s each independently represent one selected from the group consisting of an alkyl group having 1 to 10 carbon atoms, a cycloalkyl group having 3 to 10 carbon atoms, an alkenyl group having 2 to 10 carbon atoms, an aryl group having 6 to 20 carbon atoms, and an aralkyl group having 7 to 20 carbon atoms.]
in a ratio such that a total amount of the ester compounds is 5% by mass or less relative to a total amount of the compounds represented by the general formulas (1) to (9) contained in the monomer (A).

3. A polyimide precursor which is a polyaddition product of a monomer (A) comprising a tetracarboxylic acid dianhydride represented by the following general formula (1): 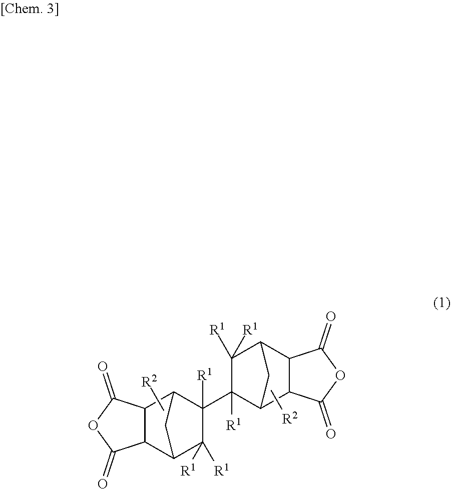
[In formula (1), R¹s each independently represent one selected from the group consisting of a hydrogen atom, an alkyl group having 1 to 10 carbon atoms, a hydroxy group, and a nitro group, or two R¹s bonded to the same carbon atom may together form a methylene group, and
R²s each independently represent one selected from the group consisting of a hydrogen atom and an alkyl group having 1 to 10 carbon atoms.]
and a monomer (B) comprising a diamine compound, wherein
a content ratio of the monomer (A) is 100.2 moles to 105 moles relative to 100 moles of the monomer (B).

4. The polyimide precursor according to claim 3, wherein the monomer (A) contains at least one ester compound selected from compounds represented by the following general formulas (2) to (9): 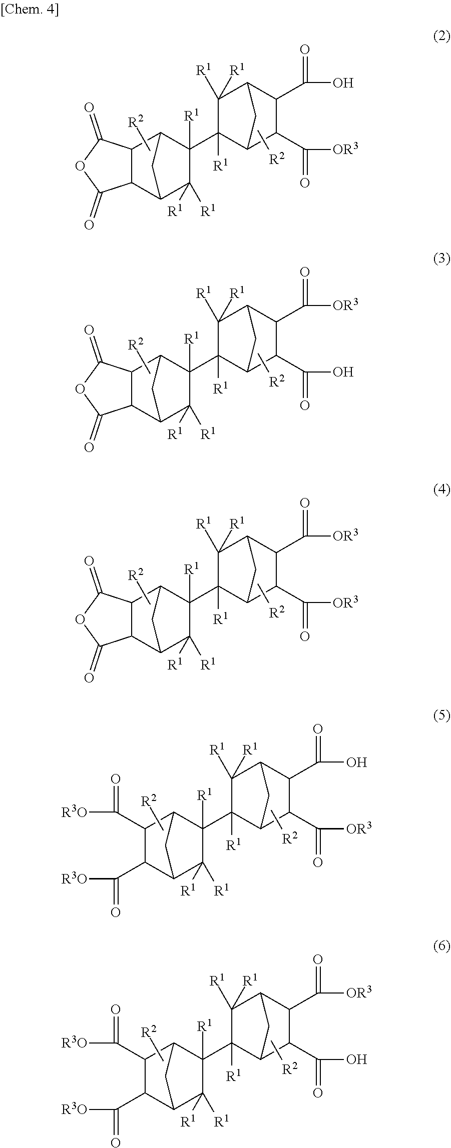 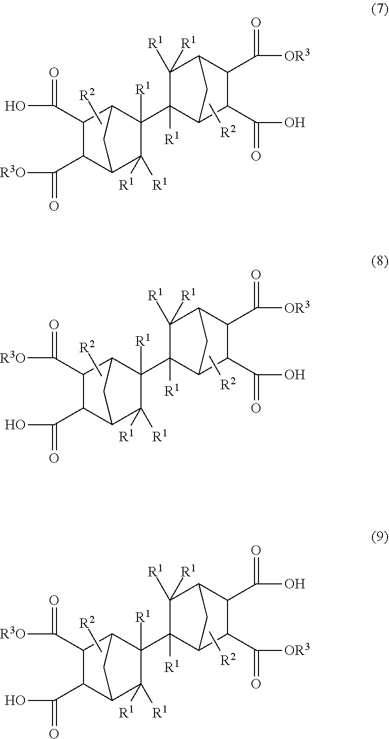
[In formulas (2) to (9), R¹ and R² are the same as R¹ and R² in the general formula (1), and R³s each independently represent one selected from the group consisting of an alkyl group having 1 to 10 carbon atoms, a cycloalkyl group having 3 to 10 carbon atoms, an alkenyl group having 2 to 10 carbon atoms, an aryl group having 6 to 20 carbon atoms, and an aralkyl group having 7 to 20 carbon atoms.]
in a ratio such that a total amount of the ester compounds is 5% by mass or less relative to a total amount of the compounds represented by the general formulas (1) to (9) contained in the monomer (A).
